(19) United States
(12) Patent Application Publication
(10) Pub. No.: US 2016/0125438 A1
(43) Pub. Date: May 5, 2016

(54) SYSTEM AND METHOD FOR FAST AND NUANCED SENTIMENT EVALUATION

(71) Applicants: Thierry GLUZMAN, Maisons Laffitte (FR); Michel Kamoun, Herzliya (IL)

(72) Inventor: Michel Kamoun, Herzliya (IL)

(73) Assignee: Michel Kamoun, Herzliya (IL)

(21) Appl. No.: 14/893,066

(22) PCT Filed: May 28, 2014
(86) PCT No.: PCT/IL2014/050478

§ 371 Date: Nov. 23, 2015

(30) Foreign Application Priority Data
May 28, 2013 (IL) 226621

(51) Int. Cl. G06Q 30/02; G06F 3/0488; G06F 3/0484

(52) U.S. Cl. CPC G06Q 30/0203; G06F 3/04847; G06F 3/0488

(57) ABSTRACT

A System and method for fast and nuance evaluation of the nature and/or intensity of the Sentiment of a Respondent in regard of a predefined Sentiment Indicator, with this person reacting to that Indicator by sliding one or several fingers on a touch sensitive surface, which sliding is analyzed according to predefined Patterns with matching sliding being translated into a Value representative of that sliding, Value that is available for instant or deferred processing, sharing or rendering on a screen.

### OPPORTUNITY

We send continuously messages to the World in order to get indications of others' Sentiments in return. Evaluating the nature and intensity of such Sentiment is needed for mutual understanding. “Public Sentiment” is commonly referring to a collective dominant opinion in regard of a brand, a product, a service or any other value, topic or concept. Businesses are continuously probing their markets in order to evaluate the nature and intensity of the public Sentiment, and from there to adjust their market strategies and operations. Many methods and tools have been developed for immemorial times by decision makers, politicians and research institutes in order to get fast and accurate evaluation of the public Sentiment.

Sentiment indicators are metrics that are commonly used by marketing professionals and media agencies to figure out the needs or trends of a market. They are also used by social analysts and psychologists to figure out a collective state of mind or average sentiment in a society or community. Accurate such indicators are obtained by evaluating and aggregating big amounts of individual Sentiments.

The traditional tools to evaluate somebody's Sentiments consist in paper or electronic ballots, questionnaires, forms or check lists. The quality and quantity of the collected data relies on the Respondent's goodwill, which is based on both perceived effort and potential benefit. Getting an accurate measure of somebody's Sentiment is for that reason hardly achieved. Getting an indication of a public Sentiment obtained from the aggregation of multiple individual sentiment is more relevant but requires large panels of Respondents, often followed by long hours of analysis or computer processing.

Some recent tools are “pull” oriented, which means that public Sentiment indicators are obtained from existing material, with no need to solicit specifically any Respondent. These recent tools analyze millions of text messages spontaneously shared through the digital networks in order to deduct an indication of the positive or negative character of a public Sentiment. Unfortunately, such analyzes not only take time and require powerful computer equipments to support complex algorithms (i.e. Natural Language Processing algorithm or “semantic analysis”, Big Data processing . . . ), but are able to deliver accurate estimates of public Sentiment only if large and sufficient quantities of text messages are available. Getting a reliable indication of an individual Sentiment is definitely out of reach, getting instead often only a false positive or false negative interpretation of a message. These tools are definitely not ideal for fast decision making, for early market trend detection, or for reacting to individual instant Sentiment.

Some other tools take advantage of the information already accumulated through the time about an individual (“profiling”) to figure out what would be the nature and/or intensity of his Sentiment about certain topic. This approach unfortunately takes time to gather enough data to draw a credible individual “profile”, and doesn't permit to detect any instant or transient Sentiment.

Some simplistic tools have also been developed with the Internet to capture promptly but roughly individual Sentiments. These tools are generally fitted for online fast rating, scoring or notation. The Respondent's input is often limited to a few discrete options as “yes” or “no”, “I like” or “I dislike”, number of stars or number of points, or an element chosen out of a predefined list. No possibility there to collect nuanced sentiments.

The current invention will improve the accuracy of individual Sentiment evaluation and will deliver instantly reliable Sentiment Indicators. It will shorten the time required for Sentiment analysis, comparison, correlation and aggregation, and will reduce all associated costs (analysts, computer resources . . . ).

### DESCRIPTION

The present invention consists in an individual Sentiment evaluation System and Method that deliver fast and nuanced indications about a Respondent's Sentiment, with a minimal effort, time and cost. This System shortens dramatically the time required for a Respondent (100) to understand a solicitation and to respond, translating the response to a Value ready for instant storage, processing, analysis, aggregation or integration within statistical dashboards or with external software applications.

The term “Sentiment” refers herein to any kind of human attitude, opinion, appreciation, assessment, preference, emotion, humor, intention, feeling or combination of such Sentiments, all with respect to a particular Topic (10).

The term “Sentiment Indicator” or “Indicator” refers herein to a string of characters, a digital code, or any visual or audio element that a Respondent can interpret as a metrics of the nature and/or intensity of a Sentiment,

The term “Value” refers herein to an indication of the nature and/or intensity of a Sentiment in response to a Sentiment Indicator, which Value is either a numerical data, an alphanumerical data, an index to point out an element in a list of predefined data, or a set of such Values,

The Sentiment evaluation is performed by the System applying an original Method:

a) a predefined Indicator (101) is presented to a Respondent (410) or selected from a list by a Respondent (301) for this Respondent to react in regard of that Indicator, a Topic for the Indicator being (310, 510, 610) or not being (like in FIG. 4) presented with the Indicator,
b) the Respondent's then reacts by sliding one or several fingers (102) on a touch sensitive surface as an expression of the nature or intensity of his Sentiment in regard of the Indicator,
c) the sliding (103) is analyzed against predefined Patterns (104) and translated by the system into a Value (105), which Pattern can be to recognize a simple linear sliding (examples: 311, 411) or a complex sliding (examples: 511, 611),
d) the Value is rendered (106) on a screen (herein the “Rendering”) simultaneously to the Sliding figuring the nature and/or intensity of a Sentiment in order for the Respondent to adjust, redo and/or validate the related Value. The Rendering may basically consist in a simple number (example: 412), or vary for each Indicator consisting in a scaled number (examples on 312: number/10, number/100 . . . ), alternative strings (examples on 313 “Yes” or “No”, “Like” or “Dislike”, “Happy” or “Unhappy” . . . ), visual indicator (examples on 314: number of highlighted stars, levered/scaled bar, gauge, traffic light . . . ), an alternative symbols (example on 315 “♂” or “♀”), an animated drawing or emotional character changing simultaneously with the “Value” (example: 316, 413), a money value in any currency (example: 317), or a physical quantity, drawing(s) or character(s) customized by the Respondent or the author of the Indicator (example: 318).
e) the said Value is optionally shared with local or remote computer equipment (107) for further storage, processing and/or Rendering (108).

The System (FIG. 2) includes predefined Sentiment Indicators (201), predefined finger Sliding Patterns (202) and optionally predefined Renderings (200). It also includes the software code and the electronic equipment to support the method, to say as a minimum:
a screen to display Indicator(s) (204), optionally a Topic, Rendering, and optionally Sliding path,
a touch sensitive surface (optionally with the screen) to catch and digitalize the finger(s) sliding (205),
data processing circuit, electronic memory and software code (203) in order to display Indicators on the screen, in order to analyze the digitalized Sliding data and to transform it into Values, in order to display the Rendering of the Values on the screen, and optionally in order to share data with external local and/or remote equipments.

### LIST OF DRAWINGS

FIG. 1—Method overview

FIG. 2—System main components

FIG. 3—Implementation of the Method—example for several Indicators at once and linear sliding Pattern

FIG. 4—Implementation of the Method—example for a single Indicator at once and linear sliding Pattern

FIG. 5, 6—Implementations of the Method—example for several Indicators at once and complex sliding Patterns

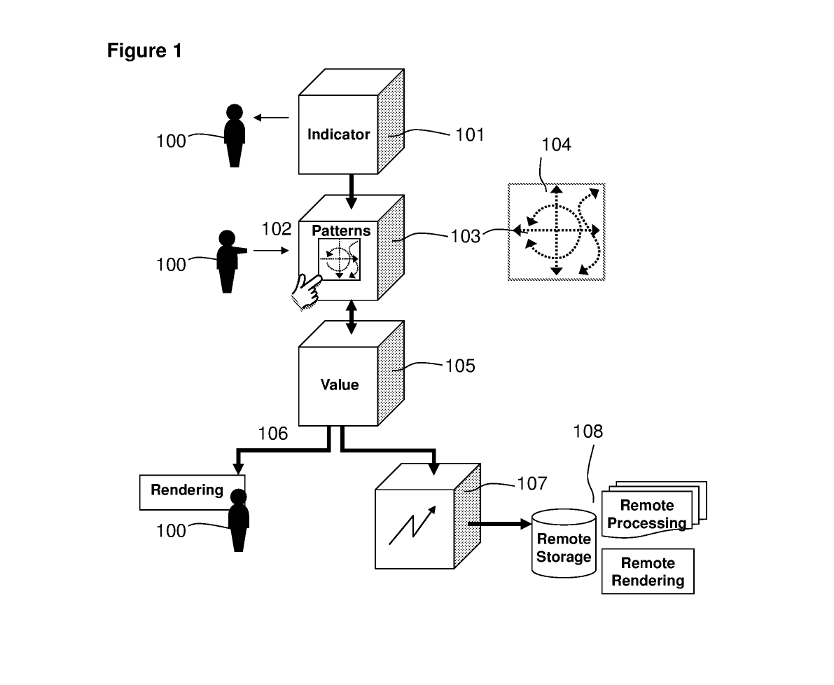

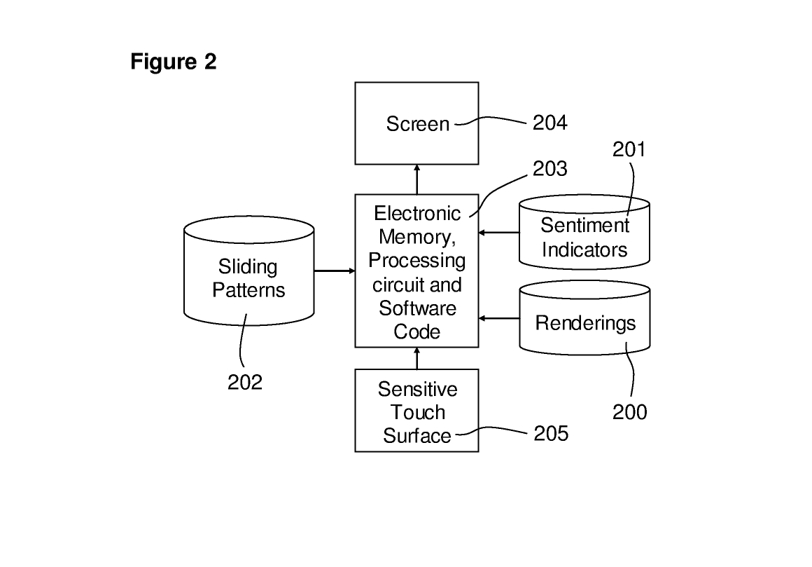

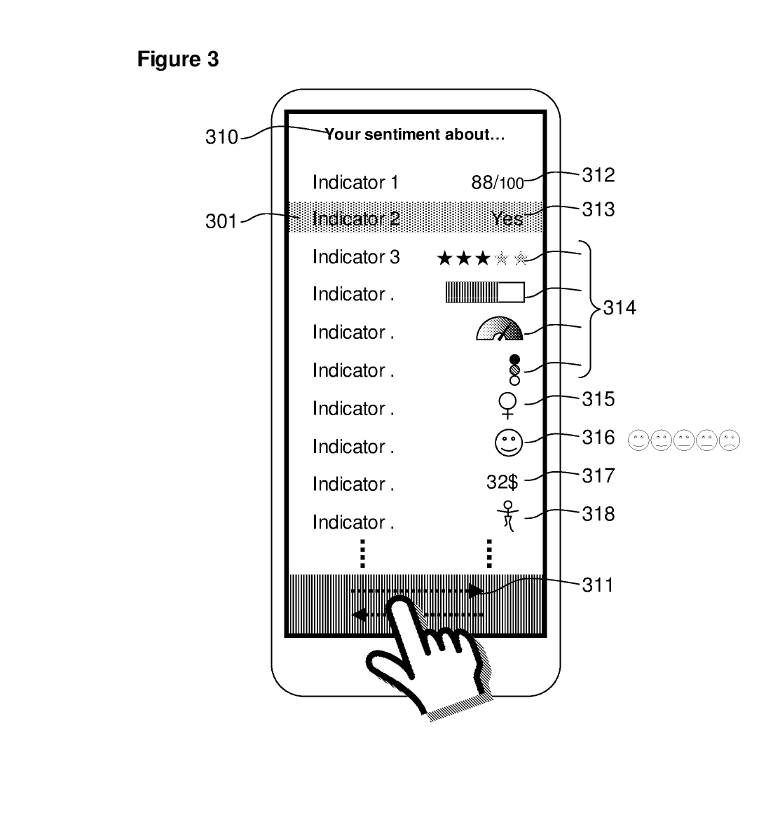

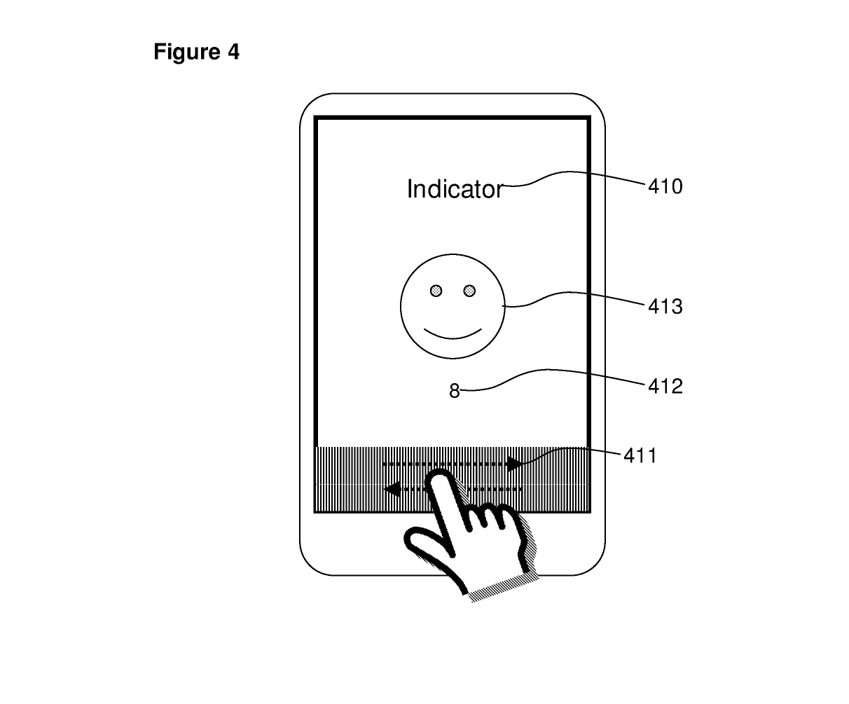

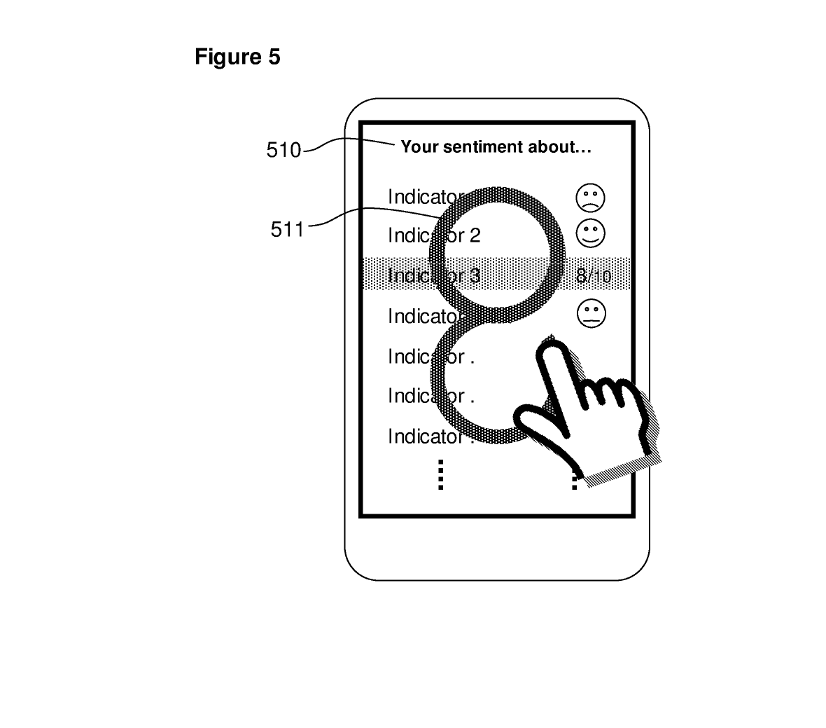

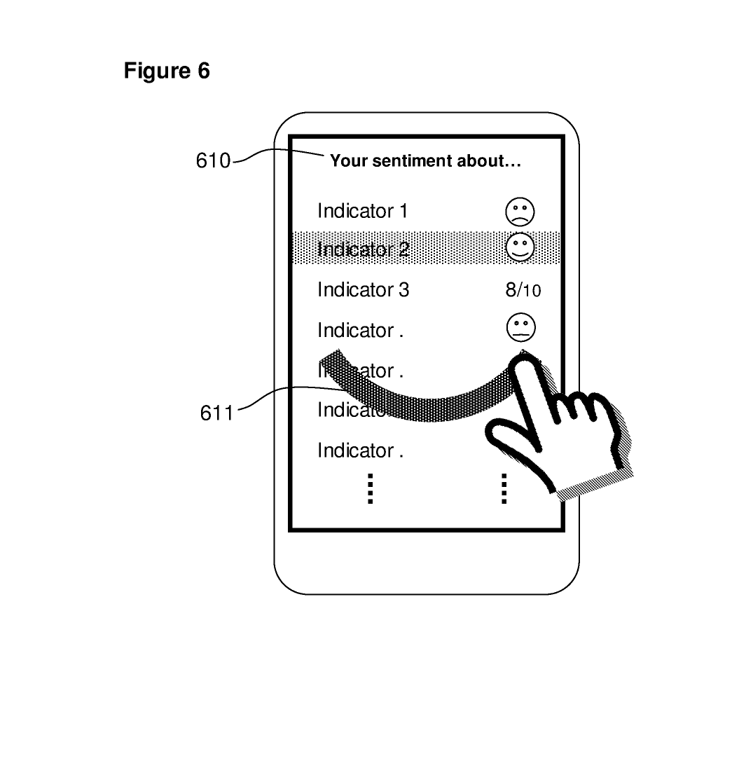

### ADVANTAGES

The invention offers a very intuitive and straightforward user interface for a Respondent to express a Sentiment with nuances, and to transform instantly that Sentiment into a “Value” that is immediately available for delivery and usage, or for aggregation with millions of others such Values, or for further processing in local or in remote without requiring big data storage, heavy computer resource or complex algorithm.

1. A System and method for fast and nuance evaluation of the nature and/or intensity of the Sentiment of a person (herein the “Respondent”) in regard of a predefined Sentiment Indicator (herein the “Indicator”), with this person reacting to that Indicator by sliding one or several fingers on a touch sensitive surface, which sliding is instantly analyzed and compared by the System to predefined Patterns (herein a “Pattern”) for if there is a match between the Sliding and a Pattern the sliding is then translated into a Value representative of that sliding (herein the “Value”), Value that is available for instant or deferred processing, sharing or rendering on a screen (herein the “Rendering”),
Where the term “Sentiment” refers to either the perception of an object or phenomenon, a mental feeling or sensibility, an emotion or humor, a thought or idea, an opinion, a view or attitude, or any combination of such Sentiments,
Where the term “Sentiment Indicator” or “Indicator” refers to a string of characters, a digital code, or any visual or audio element that a Respondent can interpret as a metrics of the nature and/or intensity of a Sentiment,
Where the term “Pattern” refers to a set of data defining a recognizable finger(s) sliding on a touch sensitive surface, which data may includes any recognizable characteristics of a finger(s) sliding, as for example the path, length, speed and/or duration of the sliding, or a sequence of such Patterns,
Where the term “Value” refers to an indication of the nature and/or intensity of a Sentiment in response to a Sentiment Indicator, which Value is either a numerical data, an alphanumerical data, an index to point out an element in a list of predefined data, or a set of such Values,
Where the term “Rendering” refers to a representation of a Value to be displayed on a screen, typically a number, which figures out the nature and/or intensity of a Sentiment,
Where the said System includes the following elements: a method (herein the “Method”), set(s) of Indicator(s), sliding Pattern(s), Rendering option(s), and Electronics Equipment and software code to support the method,
Where the Method consists in evaluating the nature and/or the intensity of the Sentiment of a Respondent by this Respondent reacting to an Indicator selected by him or automatically presented to him, where the Respondent's reaction to an Indicator is performed by the Respondent sliding one or several fingers on a touch sensitive surface (reaction herein referred as the “Sliding”), which Sliding is instantly captured, digitalized, analyzed and compared to predefined simple or complex Sliding Patterns by an electronic Equipment (herein the “Equipment”) running Pattern recognition software, where the Sliding matching a predefined Pattern is instantly translated by the Equipment into a value (herein the “Value”) that is rendered by the Equipment on a screen simultaneously to the Sliding (the “Rendering”) in order for the Respondent to visualize, adjust, redo and/or validate the figured Sentiment's nature or intensity,
Where the set(s) of Indicator(s) is predefined prior to the execution of the method, or entered by the Respondent or an Operator during the execution of the method, or loaded into the system from an external local or remote equipment before or during the execution of the method, where each Indicator can be defined or not with a preset Rendering option,
Where the sliding Pattern(s) is predefined prior to the execution of the method or loaded into the system from an external local or remote equipment before or during the execution of the method, where a Pattern can be for the recognition of a simple finger(s) transversal sliding across the touch sensitive surface, or for the recognition of more complex sliding figures,
Where the Electronic Equipment and software code include the components to support the method, to say as a minimum:
a) a screen to display Indicator(s), Rendering, and optionally Sliding path and/or Topics,
a touch sensitive surface (optionally with the screen) with the electronics to catch and digitalize the finger(s) sliding,
b) electronic memory and software code to store and read the data for Indicators and Patterns definition, and to store and read the Values,
c) electronic data processing circuit and software code in order to load and display Indicators on the screen, in order to analyze the finger(s) sliding data against predefined Patterns and to translate this sliding into the corresponding Values, in order to select a Rendering for the Value and to display this Rendering on the screen, and optionally in order to share data with external local and/or remote equipments.
Where either only a single Indicator can be submitted at once or several Indicators can be submitted at once, each Indicator in both cases along with related Rendering.

2. A System compliant with claim 1, and optionally with claims 3, 4, 5, 6, 7, 8, 9, 10, 11, 12, 13 and/or 14 whereas a text, a picture (10) and/or an audio element can optionally be submitted along with an Indicator or an all set of Indicators in order to specify or precise a Topic, a scope or a meaning for that Indicator or set of Indicator(s).

3. A System compliant with claim 1, and optionally with claims 2, 4, 5, 6, 7, 8, 9, 10, 11, 12, 13 and/or 14 whereas the Values obtained after Sliding are all coded according to a unique data format (for example a number on a scale of 0 to 100) in order to facilitate and accelerate further processing and operations such as filtering, correlation, comparison, benchmarking, aggregation with other such Values collected from multiple instances of the System and from multiple Respondents, and whereas the Values are recorded along with data related to Sliding date, Sliding time, Sliding geo-location, and/or with other Sliding characteristics in order to perform advanced statistics analysis about the conditions and/or environment of the Sliding, and whereas all processing, operations and analysis above in claim 3 can be performed by the System itself, and/or by an external local or remote computing equipment.

4. A System compliant with claim 1, and optionally with claims 2, 3, 5, 6, 7, 8, 9, 10, 11, 12, 13 and/or 14 whereas the Respondent is using a different tool than fingers on a touch sensitive surface to catch the characteristics of the Sliding; such a different tool may be for examples a stick used as a finger, a computer mouse, a joystick or any other device that can figure out a combination of moves, paths, directions, or lengths to match predefined Patterns.

5. A System compliant with claim 1, and optionally with claims 2, 3, 4, 6, 7, 8, 9, 10, 11, 12, 13 and/or 14 whereas the “Value” for a Sentiment is simultaneously to the Sliding or immediately after the Sliding transmitted to remote computing equipment for storage, further processing or distribution (7, 8) prior to the Sliding for another Sentiment Indicator.

6. A System compliant with claim 1, and optionally with claims 2, 3, 4, 5, 7, 8, 9, 10, 11, 12, 13 and/or 14 whereas only a limited area of the Screen (11 as an example) is dedicated to the Sliding by the Respondent, which area is independent of where the Topics, Indicators and Rendering are displayed.

7. A System compliant with claim 1, and optionally with claims 2, 3, 4, 5, 6, 8, 9, 10, 11, 12, 13 and/or 14 whereas the path of the Sliding is drawn on the Screen under the finger simultaneously to the Sliding.

8. A System compliant with claim 1, and optionally with claims 2, 3, 4, 5, 6, 7, 9, 10, 11, 12, 13 and/or 14 with several Rendering options, which may vary according to the related Indicator, Rendering that may consist in either a simple number, a scaled number (examples: number/10, number/100 . . . ), alternative string(s) (examples: “Yes” or “No”, “Like” or “Dislike” . . . ), visual indicator (examples: number of highlighted stars, levered/scaled bar, gauge, traffic light . . . ), an alternative symbols (example: ♂ or ♀), an animated drawing or emotional character changing simultaneously with the “Value”, a money value in any currency, or a physical quantity, drawing(s) or character(s) customized by the Respondent or the author of the Indicator. Where the Rendering options are predefined prior to the execution of the method or loaded into the System from an external local or remote equipment before or during the execution of the method.

9. A System compliant with claim 1, and optionally with claims 2, 3, 4, 5, 6, 7, 8, 10, 11, 12, 13 and/or 14 whereas a set of Indicator(s) is associated with a unique numerical or alphanumerical identifier, and/or a visual code (bar code, QR code . . . ) that can be read by an internal or external electronic equipment (i.e. a scanner) in order for the System to identify the set of Indicator(s) to be submitted to a Respondent.

10. A System compliant with claim 1, and optionally with claims 2, 3, 4, 5, 6, 7, 8, 9, 11, 12, 13 and/or 14 whereas a Respondent can attach a set of data (examples: text, network address, music, video, sound and/or image) as a complement or comment to his Sentiment in regard of an Indicator.

11. A System compliant with claim 1, and optionally with claims 2, 3, 4, 5, 6, 7, 8, 9, 10, 12, 13 and/or 14 that can present to the Respondent elements such as a texts, network addresses, music, video, sounds and/or images, which elements are received from a local or remote computing equipment in reaction or response to prior Sliding by the Respondent.

12. A System compliant with claim 1, and optionally with claims 2, 3, 4, 5, 6, 7, 8, 9, 10, 11, 13 and/or 14 whereas the Respondent can provide personal or complementary information before or after having reacted to a set of Indicator(s) (examples: age, gender, job, occupation, hobbies, revenue, home location, company, physical characteristics, preferences, personal contacts, current geographic location . . . ) to serve as an input for advanced statistics and processing by the Electronic Equipment, and/or by an external local or remote equipment.

13. A System compliant with claim 1, and optionally with claims 2, 3, 4, 5, 6, 7, 8, 9, 10, 11, 12 and/or 14 that allows the Respondent to create himself an Indicator and/or to share that Indicator with other potential Respondents through private or public network, in order to collect the individual and/or aggregated Sentiments of other Respondents.

14. A System compliant with claim 1, and optionally with claims 2, 3, 4, 5, 6, 7, 8, 9, 10, 11, 12 and/or 13 whereas the result of the aggregation of values by the System or by an external equipment (values that are related to a same Indicator but collected from different Respondents) is rendered by the System before, along or after the said Indicator is submitted, in order for the Respondent to know about other Respondents aggregated.

15. A System compliant with claim 1, and optionally with claims 2, 3, 4, 5, 6, 7, 8, 9, 10, 11, 12, 13 and/or 14 whereas the [symbol] .
